(19) United States
(12) Patent Application Publication
(10) Pub. No.: US 2025/0242547 A1
(43) Pub. Date: Jul. 31, 2025

(54) METHOD FOR PRODUCING A 3D STRUCTURE IN A 3D PRINTING METHOD

(71) Applicant: Laempe Mössner Sinto GmbH, Barleben (DE)

(72) Inventors: Frank WEDEMEYER, Zell im Wiesental (DE); Rudolf WINTGENS, Schopfheim (DE); Florian HEINRICH, Straßkirchen (DE)

(21) Appl. No.: 18/854,173

(22) PCT Filed: Apr. 4, 2023
(86) PCT No.: PCT/DE2023/000023

§ 371 Date: Oct. 4, 2024

(30) Foreign Application Priority Data
Apr. 11, 2022 (DE) 10 2022 001 231.6

(51) Int. Cl. B29C 64/386; B33Y 10/00; B33Y 50/00

(52) U.S. Cl. CPC B29C 64/386; B33Y 10/00; B33Y 50/00

(57) ABSTRACT

In a method for producing a 3D structure in a 3D printing method, the 3D printing data are data of a target geometry of the 3D structure; the generated 3D structure is three-dimensionally measured after the 3D structure is generated by generating three-dimensional de facto incomplete data of an actual geometry of the 3D structure which are reproduced in a model that comprises one or more unscanned regions; first deviations between points P on a surface of the target geometry of the 3D structure and associated points P′ on the surface of the actual geometry of the 3D structure are determined in the scanned regions; further deviations in the unscanned regions of the surface of the generated 3D structure are determined; and corrected 3D printing data are generated by means of these determined first and further deviations.

The invention relates to a method for producing a 3D structure in a 3D printing process, in which, for a 3D structure to be created from 3D print data, which are data regarding a target geometry of the 3D structure, first layer data for the individual layers of the 3D structure to be created are provided and are used to control the creation of the 3D structure in a 3D printing process.

It is known to use what is known as 3D printing or what is known as a 3D printing process to produce individual or serial components, workpieces or molds. In such printing processes, three-dimensional components or workpieces are produced in a manner built up in layers.

The building up takes place in a computer-controlled manner based on one or more liquid or solid materials in accordance with specified dimensions and shapes. Specifications for the components or workpieces to be printed (3D structures) may be provided for example by what are known as computer-aided design (CAD) systems in the form of 3D print data.

When the 3D structures or 3D components are printed, physical or chemical hardening processes or a melting process take place in a particulate construction material, which is also referred to as molding material. By way of example, construction materials or molding materials such as plastics, synthetic resins, ceramics, unsolidified sediments such as minerals or sands and metals are used as materials for such 3D printing processes in what are known as powder bed processes or coating processes. In addition, extruding or contour-based processes that use plastics or metals are also known.

Various manufacturing process sequences are known when implementing 3D printing processes.

However, many of these process sequences comprise the following process steps, set forth by way of example:
Partial-surface or full-surface application of particulate construction material, also referred to as particle material or powdered building material, to what is referred to as a construction field, in order to form a layer of non-solidified particle material, wherein the partial-surface or full-surface application of particulate construction material comprises dispensing and smoothing the particulate construction material;
Selectively solidifying the applied layer of non-solidified particulate construction material in predetermined partial regions, for example by selectively compacting, printing or applying treatment agents, such as for example a binder, by way of a print head or the use of a laser;
Repeating the previous process steps in a further layer level in order to build up the component or workpiece in layers. For this purpose, provision is made to lower the component or workpiece, which is built up or printed on the construction field in layers, with the construction field in each case by one layer plane or layer thickness, or to raise the 3D printing device in each case by one layer plane or layer thickness relative to the construction field, before a new layer is applied over a partial surface or full surface;
Subsequently removing loose, non-solidified particulate construction material surrounding the manufactured component or workpiece.

A particulate construction material is generally understood to mean a collection of individual particles of a material or a mixture of materials, wherein each particle has a three-dimensional extent. Since these particles may be understood predominantly as round, oval or even elongate particles, it is possible to specify an average diameter for such a particle, which is usually in the range between 0.01 mm and 0.4 mm. Such a particulate construction material may have fluid properties.

The prior art discloses various methods for creating a 3D structure or for dispensing and applying particulate construction material to a construction field in order to create a 3D structure.

DE 10117875 C1 discloses a method and a device for applying fluids and the use thereof.

The method for applying fluids relates in particular to particle material that is applied to a region to be coated, wherein the fluid is applied to the region to be coated upstream of blade, as seen in the forward direction of movement of the blade, and then the blade is moved over the applied fluid.

The object is to provide a device, a method and the use of the device, by way of which it is possible to achieve a distribution, which is as flat as possible, of fluid material over a region to be coated.

As a solution, provision is made for the blade to perform an oscillation in the manner of a rotational movement. The oscillating rotational movement of the blade fluidizes the fluid applied to the region to be coated. Not only does this mean that particle material, which is highly prone to agglomeration, is able to be applied as flatly and smoothly as possible, but it is also possible to influence the compaction of the fluid through the oscillation.

In one preferred embodiment, provision is made for the fluid to be applied in excess to the region to be coated. The constant movement of the blade, which oscillates in the manner of a rotational movement, thus means that the excess fluid, seen in the forward direction of movement of the blade, is homogenized upstream of the blade in a roller formed of fluid or particle material by the forward movement of the blade.

This means that any cavities between individual particle agglomerations are able to be filled and larger agglomerations of the particle material are broken up by the roller movement.

The term dimensional accuracy is known from the field of manufacturing and means that the actual dimensions of a workpiece should be within the agreed permissible deviation from the stipulated nominal dimension.

According to the prior art, when creating 3D structures, measures are carried out in order to achieve this dimensional accuracy or in order to reduce deviations between a 3D structure to be manufactured and a 3D structure created in 3D printing.

U.S. Pat. No. 10,769,324 B2 discloses a method for scanning a second part of a printed 3D structure and for modifying 3D print data for a first part of a 3D structure, in which modified, predistorted 3D specifications for the first part are created, taking into account the print characteristics, based on the scan of the second part.

One disadvantage of the known prior art is that, usually, an insufficient quality inspection is carried out on the created 3D structures with regard to deviations from predefined dimensions.

In the event that a quality inspection is carried out on the created 3D structures, for example by measuring the created 3D structures, the recognized deviations from specified dimensions of the 3D structures may be corrected for example by mechanical readjustment of components or of assemblies of the 3D printer.

However, such mechanical readjustments are usually complex, since for example it is necessary to partially disassemble the 3D printer in order to reach the components or assemblies to be adjusted. In addition, such readjustments also require the 3D printer to be shut down, that is to say require interruption of the creation of a 3D structure in the 3D printer.

This is highly disadvantageous in particular in fields in which very tight tolerances are specified in the production of 3D structures. Such tolerance ranges are for example between +0.3 mm and −0.3 mm in terms of specified maximum deviations. Consequently, a manufactured 3D structure may have an oversize of up to 0.3 mm or an undersize of up to 0.3 mm in a first dimension, such as for example its length, in order to comply with the specified tight tolerance.

Thus, according to the prior art, there is only an insufficient and/or complicated option for carrying out an appropriate quality inspection or quality assurance when creating 3D structures.

There is thus a need to improve the known prior art and thus for an improved method for producing a 3D structure in a 3D printing process.

The object of the invention is to specify a method for producing a 3D structure in a 3D printing process, whereby the 3D print data, used for the 3D printing process, for the 3D structure to be created are corrected in automated fashion in the event of deviations occurring during the manufacture of the 3D structures.

The intention is in particular for the deviations occurring during the production of the 3D structure in the 3D printing process to be reduced in this way.

This automated correction of the 3D print data used for the 3D printing process is intended to take place in particular also in regions on the surface of the 3D structure that are not accessible to a three-dimensional scan of the surface.

The object is achieved by a method for producing a 3D structure in a 3D printing process having the features as claimed in claim 1 of the independent claims. Developments are specified in the dependent claims.

Such 3D printing processes include all processes in which the component geometry is created by applying a liquid or pasty medium in layers to a substrate and subsequent solidification. By way of example and without any claim to completeness, stereolithography, laser and electron beam melting, binder and material jetting, deposition welding, digital light processing and fused filament fabrication may be mentioned here. Provision is made to use the method for producing a 3D structure in a 3D printing process to create a 3D structure in accordance with the known prior art, for example by way of a powder bed-based binder jetting process.

Even though the present method for producing a 3D structure in a 3D printing process is described below with reference only to the example of the binder jetting process, this does not represent any restriction of the method to this 3D printing process.

It is known that, in such a 3D printing process, 3D print data regarding the target geometry of the 3D structure are converted into specific instructions for the creation of individual layers in the 3D printing process, which are also referred to as layer data and by way of which the creation of the 3D structure in a 3D printing process is controlled.

After the desired 3D structure has been created on a construction field of the 3D printer in an additive manufacturing process, such as the binder jetting process, said 3D structure hardens, the non-solidified particulate construction material is removed and the 3D structure is thus exposed.

As a result of the 3D printing itself, the subsequent hardening or any post-processing that is required, in which remnants of the particulate construction material are removed from the created 3D structure mechanically and/or by way of an air flow, it is possible that the desired target geometry of the 3D structure as specified by the 3D print data does not match a created actual geometry of the 3D structure.

If such deviations of the actual geometry from the target geometry do not exceed previously stipulated tolerances, the 3D structure is dimensionally accurate; if the tolerances are exceeded, the 3D structure is not dimensionally accurate.

Such deviations are also referred to as warpage or shrinkage. Such warpage may also be caused by handling or transporting the created 3D structures.

Such warpage may be divided into two groups: what is known as deterministic warpage and what is known as non-deterministic warpage. Deterministic warpage is characterized in that it occurs repeatedly when creating multiple 3D structures having the same 3D print data or print parameters, and is thus reproducible.

Examples of such deterministic warpage:
Material-related, caused by deviations in the grain size and grain distribution of the particulate construction material;
Installation-related, caused by deviations in manufacturing tolerances, by machine vibrations or mechanical warpage within the 3D printer;
Manufacturing process-related, caused by deviations between target and actual values of speeds of the working equipment of the 3D printer, such as a print head, an application element or a smoothing means, by deviations of the exact time when the nozzle of the print head is actuated or by deviations of the amount of binder to be output by a nozzle of the print head, etc.;
Diffusion processes, for example in a microwave or sintering oven, during hardening of the 3D structure;
Cleaning steps, post-processing steps and/or transport steps.

### Non-Deterministic Warpage:

Does not occur in a stable and systematic manner, but rather randomly, and is not reproducible.

Owing to such deterministic warpage occurring, it is necessary to run in the process of creating 3D structures for each new geometry or 3D structure. In order to be able to dispense with complex mechanical adjustment of the components and assemblies of the 3D printer, there is the option to adjust the 3D print data manually in order to achieve the target geometry.

In this context, the created 3D structure has to be captured at least once, for example by way of a 3D scan, in order to provide data regarding the geometry of the created 3D structure. It is possible to use other suitable methods to capture dimensions of the created 3D structure.

One problem when measuring a created 3D structure in this way, for example by way of a 3D scanning method, is that a 3D scanning method might possibly not be able to provide scan data, for example in the form of what is known as a point cloud, in relation to all regions of the created 3D structure. Such a point cloud comprises the three-dimensional measurement points generated by the 3D scanning method and describing the surface of the 3D structure.

The reason for missing scan data for describing the surface of the 3D structure are regions of the created 3D structure that are not able to be reached by the sensors of a 3D scanning device, since these regions are located behind the regions “visible” to the sensors of a 3D scanning device. Such regions are also referred to as undercuts, dead zones, dead angles or hereinafter as unscanned regions.

Unscanned regions may also be considered to be regions in which only very few measurement points were generated in a 3D scan. An excessively low measurement point density allows only a limited statement or no statement regarding possible deviations between an actual model of a 3D structure and the target model of this 3D structure.

The model of the surface of the created 3D structure, as created by way of a 3D scanning method, thus does not completely map the created 3D structure in the form of data regarding the scanned actual geometry, and has what are referred to as unscanned regions.

According to the prior art, such unscanned regions may be inferred for example by an interpolation, wherein for example a surface is thereby formed over the open region. Owing to the only few measurement points, generated by the 3D scanning method, in or near the unscanned region, which are usually located only at the edge of the unscanned region, it is not possible to exactly reproduce the exact outer contours of the surface of the 3D structure in these unscanned regions. In the event that a few generated measurement points are present in the unscanned region, the surface or the contours of the 3D structure is or are reproduced partly in the manner of steps or stairs, and this thus also does not correspond to the exact profile of the surface or outer contours of the 3D structure.

In the case of less complex 3D structures, this process of inferring regions or surfaces in this way represents a possible approximation to the created actual geometry of the surface of the 3D structure. In applications with low specified tolerances between the target geometry of the 3D structure and the actual geometry of the 3D structure, such methods of inferring regions or surfaces are usually excessively inaccurate.

According to the present method for producing a 3D structure in a 3D printing process, provision is made,
for a 3D structure to be created from 3D print data, which are data regarding a target geometry of the 3D structure, for first layer data for the individual layers of the 3D structure to be created to be provided and used to control the creation of the 3D structure in a 3D printing process,
for a created 3D structure to be measured in three dimensions, wherein in practice incomplete three-dimensional data regarding a scanned actual geometry of the 3D structure, a surface of the created 3D structure, are generated and are mapped in a model having one or more unscanned regions,
for first deviations between corresponding points P and P′ in the scanned regions to be determined in a projection step, wherein the point P is respectively located on a surface of the target geometry of the 3D structure and the associated point P′ is respectively located on the model of the surface of the scanned actual geometry of the 3D structure,
for these ascertained first deviations to be stored, with their value, as deviation data in relation to associated points P₁, P₂, P₃, . . . , Pₙ of the data regarding the target geometry of the 3D structure,
for further deviations belonging to the unscanned regions of the surface of the created 3D structure to be completed, in a completion step, using the data regarding the target geometry of the 3D structure and the already ascertained first deviation data, and for the generated further deviation data in relation to associated points P of the data regarding the target geometry of the 3D structure to be stored with their value, and for deviation data completed in this way to be generated,
for corrected 3D print data to be generated in a deformation step, in which points P of the data regarding the target geometry of the 3D structure are displaced by a magnitude, dependent on the first or further deviation, of the stored value in a direction opposite the ascertained first or further deviation on the basis of the stored first or further deviation ascertained in relation to the respective point P;
for these corrected 3D print data to be used to control the creation of subsequent 3D structures in a 3D printing process.

Data regarding a target geometry of the 3D structure are converted, as is known from the prior art, into data for the individual layers of the 3D structure to be created and the creation of a 3D structure in a 3D printer is controlled using these data.

By way of example, the 3D structure created in this way is removed from the print bed of the 3D printer, post-processed and cleaned. This step may also include the process of hardening the 3D structure.

The created 3D structure is measured in three dimensions in a measurement step. This measurement process may be performed for example by way of an appropriate laser scanning device. As a result of such a measurement, three-dimensional, in practice often incomplete data regarding the actual geometries of the created 3D structure are present as a model of the actual geometry. These data are incomplete because there are no data for unscanned regions that were not reached during the three-dimensional measurement.

Subsequently, first deviations between corresponding points P′ and P on a surface of the model of the actual geometry of the 3D structure and associated points on the surface of the target geometry of the 3D structure in the scanned regions are determined in a projection step.

These first deviations, with their magnitude, may be determined for each point P′ present in the 3D print data on the surface of the model of the actual geometry of the 3D structure and a respectively associated corresponding point P on the surface of the target geometry of the 3D structure. If for example a point P′, ascertained by way of a laser scan, on the surface of the model of the actual geometry of the created 3D structure is located below the surface of the target geometry of the 3D structure to be created, the deviation at this point P has an undersize.

In the event that a point P′, ascertained by way of a laser scan, on the surface of the model of the actual geometry of the created 3D structure is located above the surface of the target geometry of the 3D structure to be created, the deviation at this point P has an oversize.

In the event that a point P′, ascertained by way of a laser scan, on the surface of the model of the actual geometry of the created 3D structure is located on the surface of the target geometry of the 3D structure to be created, no deviation occurs at this point P.

When ascertaining the deviations, such as for example the first deviations, corresponding points P′ and P on the model of the actual geometry of the created 3D structure and the target geometry of the 3D structure to be created are compared in pairs that would be located on top of one another without any deviation occurring between the surfaces of the actual geometry and the target geometry of the 3D structure.

For each three-dimensional point P on the target geometry of the 3D structure for which a corresponding point P′ has been ascertained in the model of the data regarding the scanned actual geometry in the scanning process, a first deviation between the actual geometry of the 3D structure and the target geometry of the 3D structure may be or is ascertained in a projection step and stored. The first deviations therefore cannot be determined in unscanned regions, since it was not possible to provide any point P′ in the model of the data regarding the scanned actual geometry in these regions.

As an alternative, these first deviations may be determined for specified regions on the surface of the 3D structure. Such deviations may also be an average for a specified region on the surface of the 3D structure.

The first deviations ascertained in this way are stored, with their value, as deviation data in relation to associated points P of the data regarding the target geometry of the 3D structure and may thus be used in the further method sequence.

The first deviations ascertained in relation to the scanned regions are used in the process of ascertaining further deviations or further deviation data in the unscanned regions of the surface of the model of the created 3D structure. If ascertained first deviations at an edge of an unscanned region are known, it may be assumed that the ascertained first deviations at the edge of the unscanned region also continue further into the unscanned region with a comparable magnitude or value.

Since the ascertained first deviations at the edges of the unscanned regions are known, it is possible to ascertain further deviations or further deviation data in the unscanned regions such that this information is transferred from known points in the scanned region successively to points in the unscanned region, with the aid of small assumed partial surfaces, and step-by-step completion of the further deviations missing from the unscanned regions is achieved. In this case, the points are located at vertices of the small assumed partial surfaces, these being for example the triangular partial surfaces used in a process of triangulating the surface of the target structure to be created.

Such partial surfaces filling the unscanned region may be polygons or free-form surfaces with vertices, in particular triangles. The method is explained below preferably with reference to target geometries described by triangular partial surfaces, which does not mean restricting the method to these partial surfaces.

In this case, both the already ascertained first deviation data and the further deviation data, still to be ascertained for the unscanned regions, in relation to points P at the corners of the partial surfaces are ascertained and stored. When using free-form surfaces, the deviation data are stored in relation to appropriately definable points.

Provision is made here for the ascertaining of further deviations in the unscanned regions to begin at the edge of the unscanned region and for this process to be continued in the direction of an assumed center of the unscanned region.

Provision is furthermore made for the small partial surfaces of the target geometry with their respective vertices, which are used to ascertain further deviations in the unscanned regions, to be triangular partial surfaces, for example. These small triangular partial surfaces are used to iteratively ascertain further deviations beginning at the edge of the unscanned region until all further deviations have been ascertained and stored in relation to the respective points for the unscanned region.

The process of ascertaining further deviations or further deviation data is explained in more detail below with reference to an example:

A prerequisite for ascertaining further deviations is that the surface of the target component, that is to say the surface of the target geometry of the 3D structure, is already present in a triangulated form. Such triangulation is carried out in a conversion step, wherein the surface of the target geometry of the 3D structure to be created is covered or reproduced completely, for example by way of multiple triangular partial surfaces, wherein the corners of the partial surfaces are each assigned points in the form P₁, P₂, P₃, . . . , Pₙ. Data in relation to neighborhood relationships of points P₁, P₂, P₃, . . . , Pₙ are thus present at the corners of the triangular partial surfaces, which are used subsequently.

Triangular partial surfaces on the surface of the target geometry are determined, these being located at the edge of the unscanned region and in which first deviation data have already been determined at two corners in a projection step. In the example, this may be a triangular partial surface of a triangle having the vertices P₁, P₂, P₃, for which first deviations in relation to the vertices P₁ and P₂ are known, since here two first deviations were able to be ascertained in each case between corresponding points P₁ and P₁′ and P₂ and P₂′. However, it is not possible to ascertain deviations between corresponding points P and P′ in the unscanned regions, since there are no data in relation to the points P′ in these regions.

When determining or ascertaining further deviations, it is assumed that the value or magnitude of the ascertained first deviations at the edges of the unscanned region continues into the unscanned regions with comparable values or amplitudes for the further deviations to be ascertained. In the example, a further deviation for the vertex P₃ may be determined by way of a mathematical function, wherein for example an arithmetic average is ascertained from the first deviations known for the points P₁ and P₂. The ascertained first and further deviations for the points P₁, P₂ and P₃ have a value or magnitude for the ascertained deviation, wherein the directions of the deviations extend in each case along the corner normals, associated with the points P₁, P₂ or P₃, of the triangular partial surfaces.

Ascertaining a further deviation for the vertex P₃ by way of a mathematical function, such as arithmetic averaging from the first deviations known for the points P₁ and P₂, is given by way of example. In practice, other functions or calculation rules may be stored in addition to averaging, which take into account for example more complex partial surface constellations encompassing multiple points, priority weightings for strongly differing first deviations or the degree of uncertainty of a certain further deviation due to the distance from an ascertained first deviation.

Area-weighted averaging, angle-weighted averaging or distance-weighted averaging may also be used as function, such that not only the neighborhood relationships are incorporated into the calculation, but also the existing geometric occurrences, for instance, in the case of distance weighting, closer points have a higher influence than those further away.

After ascertaining the further deviation for the vertex P₃, for example, a further triangular partial surface on the surface of the target geometry is determined, this being located at the edge of the unscanned region and in which first deviation data have already been determined at two corners in the projection step. In the example, this may be a triangle P₂, P₄, P₅, for which first deviations in relation to the vertices P₂ and P₄ are known, since here the first deviations were able to be ascertained in each case between corresponding points P₂ and P₂′ and P₄ and P₄′. Ascertaining the further deviation for the vertex P₅ is again achieved for example by way of mathematical averaging from the first deviations known for the points P₂ and P₄.

Such ascertaining of further deviations for the corresponding vertex of further triangular partial surfaces may be continued for example along the edge of the unscanned region until a first row of triangular partial surfaces has been used to determine the further deviations along the entire edge region. This process of ascertaining further deviations on the basis of known first deviations for corresponding vertices or points P₁, P₂, P₃, . . . , Pₙ on the surface of the target geometry of the 3D structure to be created is an iterative process that makes use of the triangular partial surfaces of the triangular partial surfaces created during the triangulation of the surface of the target geometry, and not triangular partial surfaces created when ascertaining further deviations.

If for example a first row of further deviations has been ascertained close to the edge of the unscanned region, the ascertaining of further deviations may be continued in a region further away from the edge of the unscanned region, for example in a second row.

Further deviations may continue to be ascertained by way of a further triangular partial surface having the vertices P₃, P₅, P₆, for which the further deviations in relation to the vertices P₃ and P₅, as described above in the case of ascertaining the further deviations in relation to the vertices P₃ and P₅, were ascertained.

The further deviation in relation to the vertex P₆ may be ascertained in the manner described above, for example by way of arithmetic averaging.

This continuation of ascertaining further deviations in a further row, wherein this further row is further away from the edge of the unscanned region than the first row, is given by way of example.

The process of ascertaining further deviations in relation to the points P₇, P₈, P₉, . . . , Pₙ in the unscanned region is continued iteratively in this way until further deviations have been generated for example for the entire unscanned region.

Further deviations in relation to points P₁, P₂, P₃, . . . , Pₙ are ascertained, according to the method, independently of the surface profile of the created 3D structure, which represents a particular advantage of the method.

In this procedure, gradations may occur between neighboring points P, in particular in the region of an imaginary center of the unscanned region, for example as a result of various first deviations at different edges of the unscanned region, in the subsequent deformation. These gradations are caused by excessively different values or magnitudes of the ascertained further deviations, for example between neighboring points P.

Provision is made for the further deviations ascertained within the unscanned region to be smoothed.

As an alternative, provision is made for the first deviations and the further deviations to be smoothed.

In this smoothing, gradations that otherwise occur during a subsequent deformation step are reduced by reducing such abrupt deviations between neighboring deviation values by correcting the deviation values ascertained in relation to the corresponding points P₁, P₂, P₃, . . . , Pₙ in each case for example by way of smoothing rules that take into consideration weighted averages or other values, such as distances, angles and geometry constellations, for the corresponding deviation value.

For this purpose, for example, a weighted average for a point P₁ is determined by processing the deviation value for the point P₁ itself when carrying out weighted averaging for the point P₁ and processing multiple deviation values for the points P₂, P₃, . . . , Pₙ directly surrounding and neighboring, also referred to as adjacent to, the point P₁. When using triangular partial surfaces, at least the deviation values of three neighboring points P₂, P₃, P₄ and the deviation value of the point P₁ itself are thus used in the weighted averaging.

Provision is furthermore made for the surface normals belonging to the for example triangular partial surfaces to be calculated for each triangle and converted into the associated corner normals of the vertices describing the triangle, which are used in the further method sequence.

A surface normal is a normalized, outward-pointing vector perpendicular to the surface of the triangular partial surface.

For each point, the corner normal is calculated by angle-weighted and area-weighted addition of the surface normals belonging to the adjacent or neighboring triangles and subsequent normalization.

For each point P₁, P₂, P₃, . . . , Pₙ of the target model or of the target geometry of the 3D structure, according to the method, an ascertained first or further deviation value or a magnitude and a corner normal are now present. The vector resulting from multiplying the deviation value and the corner normal then corresponds, in terms of direction and magnitude, to the displacement vector that displaces each point P of the target geometry of the 3D structure to its actual position P′ in the created actual model, that is to say the actual geometry of the 3D structure.

If this displacement vector points outward at a point P₁, P₂, P₃, . . . , Pₙ of the target geometry of the 3D structure, this means that the created 3D structure for this point is oversized in relation to the data regarding the specified target structure. If the displacement vector has a length of zero, this means that the created 3D structure for this point has no deviation in relation to the data regarding the specified target structure. If the displacement vector has a length within a tolerance, the deviation does not result in any loss of dimensional accuracy. If the displacement vector points inward, this means that the created 3D structure for this point is undersized in relation to the data regarding the specified target structure.

Provision is also made for it to be possible to ascertain data in relation to actual geometries of the 3D structures in models from multiple created 3D structures and for the data regarding the desired target geometry of the 3D structure to be compared with the data regarding the number of actual geometries of the 3D structures. This thus forms an average, generated by way of statistical methods, for the deterministic deviations, that is to say the deviations determined in relation to different points.

This makes it possible for example, in the event of a one-off first or further deviation or a one-off excessively large deviation, to launch a different error procedure than in the event of systematic deviations. This also applies to a number of first or further deviations.

In the deformation process, the point P, in order to generate the corrected 3D print data, may be displaced in the opposite direction to the ascertained deviation or to the displacement vector and for example by the magnitude thereof. In one example, the point P₁ in relation to which an undersize of 0.2 mm has been ascertained as deviation may be displaced outward by the magnitude of 0.2 mm in the opposite direction to the ascertained deviation. Deterministic warpage is thereby corrected. Conversely, for example, an oversize of 0.1 mm at a certain point P₂ on the surface of the created 3D structure may be rectified in that the corrected 3D print data for this point specify the creation of a subsequent 3D structure with an undersize of 0.1 mm. Deterministic warpage is thereby likewise corrected.

As an alternative, during the deformation, a point P₁, P₂, P₃, . . . , Pₙ may be displaced in the opposite direction to the ascertained deviation only by a partial magnitude or an increased magnitude of the ascertained magnitude of this deviation. These partial magnitudes may be defined on a user-specific basis in accordance with stipulated regions of the 3D structure or based on the existing geometry. For example, a displacement may thus be in steps of 50%, 75%, 90%, 110%, 125%, or 150% of the ascertained magnitude of a first or further deviation.

Provision is furthermore made, in the deformation step, for the points P₁, P₂, P₃, . . . , Pₙ of the data regarding the target geometry of the 3D structure to be displaced by a product given by a value, stored in relation to a first or further deviation, as a first factor and a second factor in the range of 0.3 to 1.7. The deformation is thereby able to be adjusted continuously within the described range.

Provision is made for data for the individual layers of the 3D structure to be produced also to be provided from the corrected 3D print data, using which the creation of the 3D structure in a 3D printing process is controlled. Such data are also referred to as layer data.

In one alternative, provision may be made for the ascertained first and further deviations to be used to correct the 3D print data, already available for the first print, regarding the individual layers. Corrected 3D print data regarding the individual layers of the 3D structure to be produced are thus generated and are able to be used directly to create the subsequent 3D structure in the 3D printing process. The conversion of the corrected 3D print data into data for the individual layers of the 3D structure to be produced is thus dispensed with.

The 3D print data corrected in this way are subsequently used to control creation of a further 3D structure. These corrected 3D print data thus take into account the deformations or deviations of the actual geometry of the created 3D structure in relation to the specified target geometry of the 3D structure to be created. By way of example, an ascertained first or further deviation, such as an undersize of 0.2 mm at a certain point on the surface of the created 3D structure, may thus be eliminated in that the corrected 3D print data for this point specify the creation of a subsequent 3D structure with an oversize of 0.2 mm.

In this example, the ascertained deviation in relation to a point P on the specified target geometry of the 3D structure to be created would for example be stored with its direction in accordance with the corner normals and its magnitude of 0.2 mm. In this case of an undersize, the direction of the ascertained deviation would be directed into the 3D structure to be created or into the specified target geometry of the 3D structure to be created or inward. In the case of an oversize, the direction of the ascertained deviation would be directed away from the 3D structure to be created or from the specified target geometry of the 3D structure to be created or outward.

Provision is made, according to the method, for the 3D printing process to be controlled so as to compensate for ascertained deviations or deterministic warpage on the basis of ascertaining, encompassing corresponding points, first and further deviation data between the actual geometry of the 3D structure to be created and the data regarding the target geometry of the 3D structure to be created over the entire surface or outer contour of the 3D structure. Determining deviations or deviation data in relation to points in the unscanned regions, according to the method, makes it possible to determine deviations or deterministic warpage even for unscanned regions that are not able to be captured.

If the process of ascertaining further deviation data in the unscanned regions results in complete deviation data being present, what is referred to as a deformed 3D structure is created, representing the corrected 3D print data. It is assumed that the production of a 3D structure using these corrected 3D print data compensates for the deterministic material-related, process-related and installation-related warpage and thus creates a 3D structure that corresponds as best possible to the data regarding the target geometry of the specified 3D structure, that is to say the 3D print data received from the CAD system.

Creating the deformed 3D structure or the corrected 3D print data comprises the following steps:

In the first step, the surface normals of the triangulated target component are calculated from the originally specified 3D print data, which are data regarding the target geometry of the 3D structure. Such surface normals are ascertained for example for small triangular partial surfaces that reproduce the surface of the 3D structure. The surface of the 3D structure may also be reproduced with partial surfaces that deviate from a triangle.

The corner normals are calculated from these surface normals.

For each triangular partial surface, for example, the corner normals now have the direction of displacement along which the determined deviations are assigned. Each point P₁, P₂, P₃, . . . , Pₙ of a triangular partial surface may be displaced along its corner normals.

The extent of the displacement along the corner normals is given by the value of the respective ascertained deviation at a point P₁, P₂, P₃, . . . , Pₙ through which the corner normal runs. The displacement may be understood as a vector whose origin is at a point P₁, P₂, P₃, . . . , Pₙ on the surface of the target geometry of the 3D structure to be created through which a corner normal runs. This vector is aligned parallel to the associated corner normal in one of two possible directions. If the deviation ascertained for a point P₁, P₂, P₃, . . . , Pₙ on the surface of the target geometry is greater than zero, the vector is directed away from the 3D structure. If the deviation ascertained for a point on the surface of the target geometry is less than zero, the vector is directed into the 3D structure in the opposite direction.

When creating the deformed 3D structure or generating the corrected 3D print data, referred to respectively as deformation or deformation step for short, a point on the surface of the 3D structure to be created that is contained in the data regarding the target geometry of the 3D structure is displaced along the associated corner normals. This point is displaced here by a magnitude dependent on the ascertained first or further deviation at this point and in a direction opposite the ascertained deviation.

This deformation of the points P₁, P₂, P₃, . . . , Pₙ of the surface of the target geometry of the 3D structure is performed for a certain number of points, for selected points or for all points, thus creating a deformed 3D structure or the corrected 3D print data.

As is customary, these corrected 3D print data regarding the deformed 3D structure are cut into layer data (slices) and the geometry data or layer data controlling the 3D printing process are thus generated.

In one alternative variant of the method for producing a 3D structure in a 3D printing process, provision is made, instead of deforming the target component, to transform the points P₁, P₂, P₃, . . . , Pₙ provided with deviation data into the coordinate system of the layer data already present from the first print and thereby to obtain corrected layer data by way of which the creation of a 3D structure in the 3D printer is controlled.

Provision is also made for corrected 3D print data or corrected 3D print data regarding the individual layers of the 3D structure to be produced to be generated, in accordance with the method, regardless of the size of the determined deviations. In this way, even the smallest detected deviations are processed in the deformation and affect the corrected 3D print data to be generated.

A program implementing the present method for producing a 3D structure in a 3D printing process is executed for example in a control unit preparing a print job, in a CAD computer or in a central control unit of the 3D printer. This central control unit also controls the process of creating the 3D structure on the basis of the 3D data, transferred thereto, regarding the dimensions of the 3D structure to be created. Such data may for example be generated by a computer-aided design system and transferred to the central control unit.

The central control unit thus has or generates parameters for actuating the 3D printer, such as for example the parameter of the time of actuation of a nozzle or the parameter of the speed of movement of work equipment of the 3D printer over the construction field. Thus, for example, the time of actuation of a nozzle parameter may be influenced by the central control unit. This time of actuation of a nozzle parameter may be shifted in time with respect to its specified value of the time of actuation by the central control unit, such that the shifted time of actuation is at a time before or after the specified value of the time of actuation. The direction of this shift depends on the direction of the ascertained deviation of the dimensions.

Whereas, according to the known prior art, usually only a small number of for example 30 supposedly representative measurement points are defined on a 3D structure and used for quality assurance, the quality inspection situation is improved massively by the method according to the invention.

The method solves this problem by completing incomplete measurements, by allowing multiple measurements of a single created component to be combined, and by allowing comparison of measurements carried out on different components of the same type when the same geometry is printed multiple times.

This comparison is made possible by storing the ascertained deviations in relation to points P of the target geometry of the 3D structure. The target geometry of the 3D structure thus serves as a common reference basis for the various ascertained deviations, as it were, and thereby makes them comparable, since deviations ascertained in relation to multiple created 3D structures are always assigned to or stored in relation to the same point P on the target geometry of the 3D structure.

As a result of the completion process, that is to say the generation of further deviation data for unscanned regions, it is possible to process a comparable number of measurement points in all measurements, which improves both the possibility of carrying out the abovementioned comparison and the quality of the process of the described deformation.

One advantage of the method is also that ascertained first and further deviations from different measurements of a created 3D structure are able to be stored in relation to associated points P of the data regarding the target geometry of the 3D structure and that different measurements on a 3D structure are thereby able to be combined. It is thereby possible to capture regions of the 3D structure on which the created 3D structure stands or rests during a first three-dimensional scan.

Furthermore, it is possible to create multiple 3D structures and to determine the complete deviation data regarding all created 3D structures in the manner described in order to be able to distinguish deterministic from non-deterministic warpage using statistical methods.

Provision is also made in the present method for a 3D structure subsequently created by way of corrected 3D print data to be measured in three dimensions in order again to ascertain first and further or complete deviations between the target geometry of the 3D structure to be created and the actual geometry of the subsequently created 3D structure. The complete deviations or complete deviation data that are then obtained are subsequently used to deform the already corrected 3D print data.

This thus results in a further improvement in dimensional accuracy. This method may be iterated. One possibility is not to carry out the described iteration directly in succession for each created 3D structure, but rather with a time interval or only after the creation of a specified number of 3D structures in order to counteract any mechanical changes in the 3D printer or the downstream processes. The need for a further iteration may alternatively be recognized by assessing the dimensional accuracy of the created 3D structures over time.

The accuracy or dimensional accuracy is thus refined iteratively, and a self-regulating adjustment process in series manufacture is made possible.

The features and advantages of this invention as explained above may be understood and appreciated better after carefully studying the following detailed description of the exemplary embodiments of the invention, which are preferred here and not restrictive, together with the associated drawings, in which:

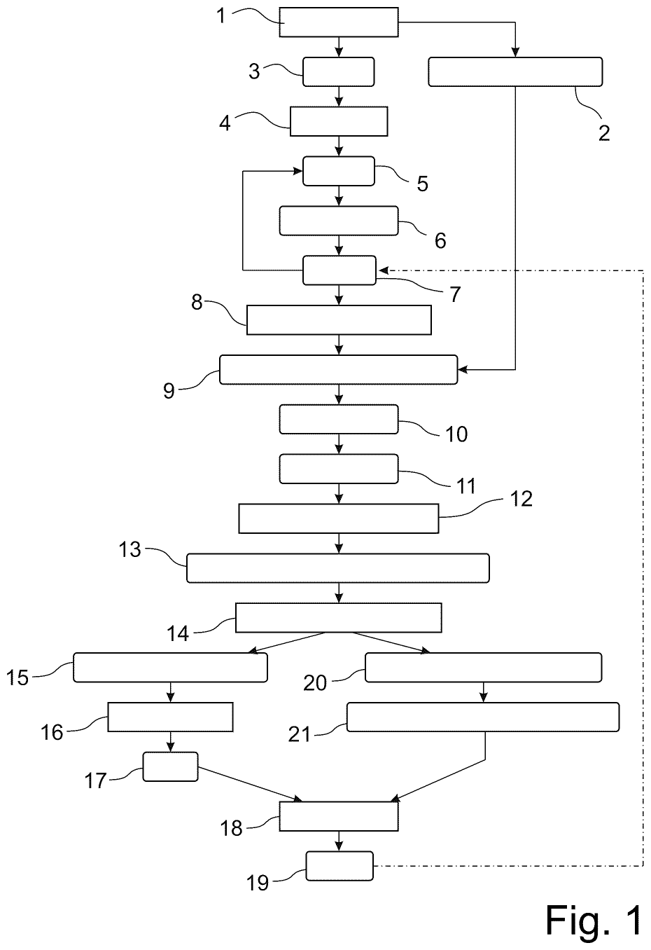

FIG. 1: shows one example of a flowchart for the method according to the invention,

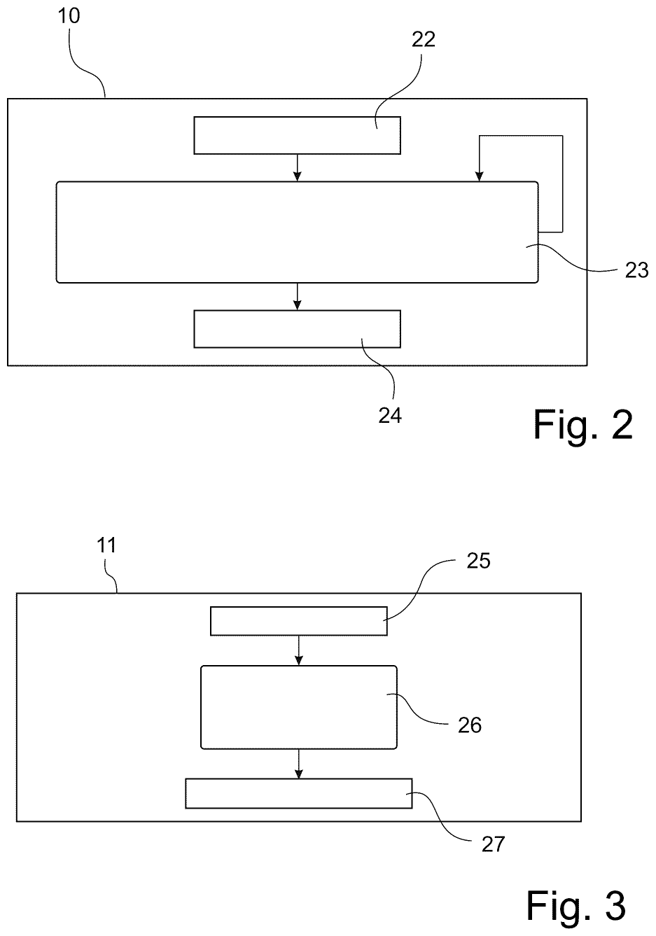

FIG. 2: shows one example of a flowchart for the process of completing the missing deviation data belonging to the unscanned regions of the surface of the created 3D structure,

FIG. 3: shows an exemplary sequence for a smoothing step,

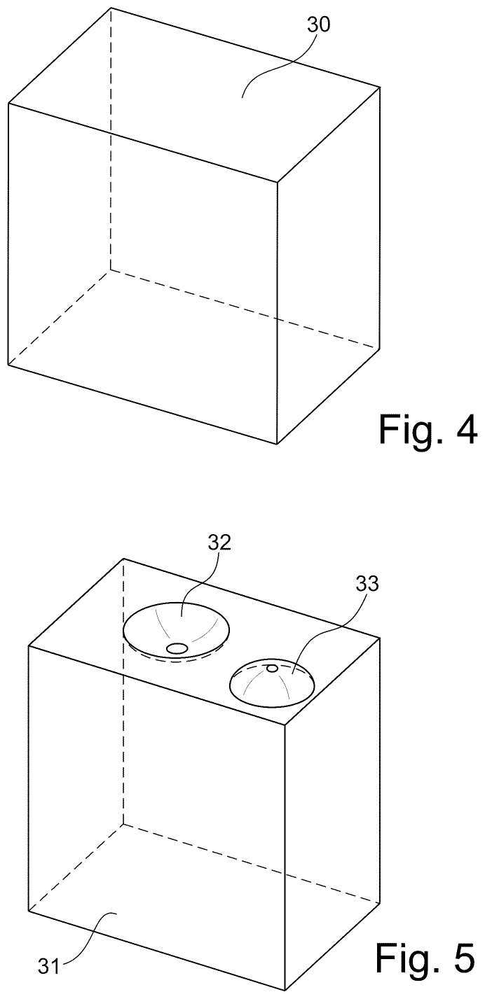

FIG. 4: shows a 3D structure to be created by way of the 3D printing process, that is to say a target geometry of the 3D structure,

FIG. 5: shows a 3D structure produced by way of the 3D printing process, that is to say an actual geometry of the 3D structure,

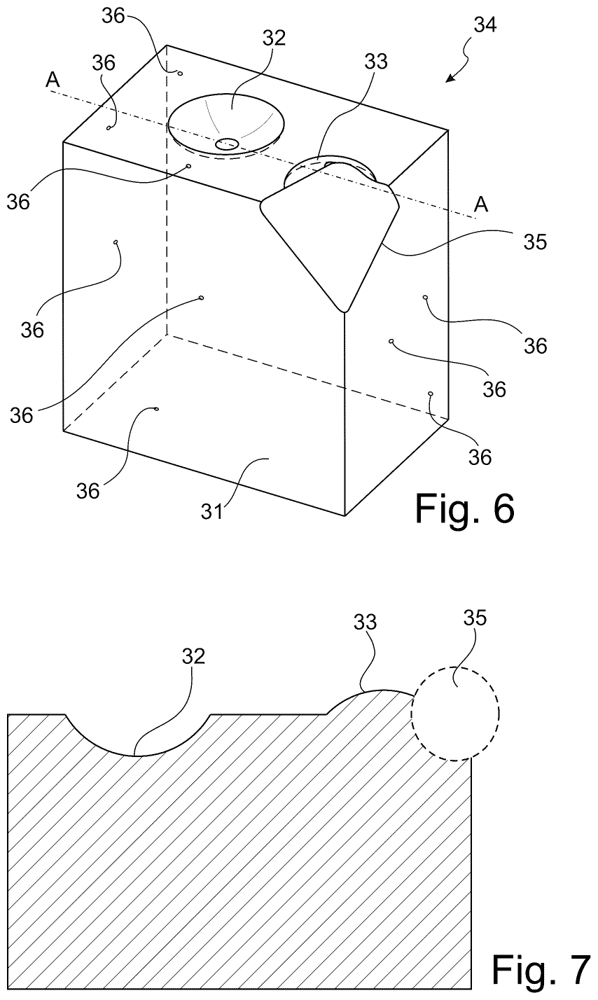

FIG. 6: shows a model of the data, provided in the measurement step, regarding the scanned actual geometry of the 3D structure,

FIG. 7: shows a sectional illustration through the model illustrated in FIG. 6, or the data regarding the scanned actual geometry,

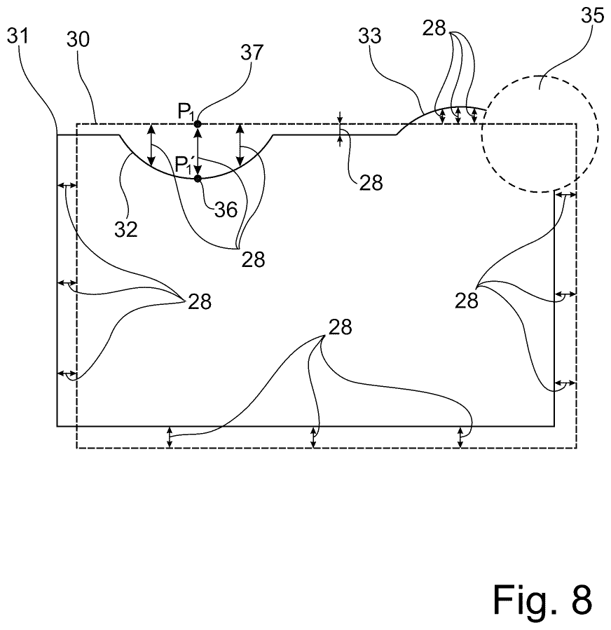

FIG. 8: shows a visualization of the projection step 9, in which the data regarding the actual geometry and the data regarding the target geometry are projected on top of one another and first deviation data are generated,

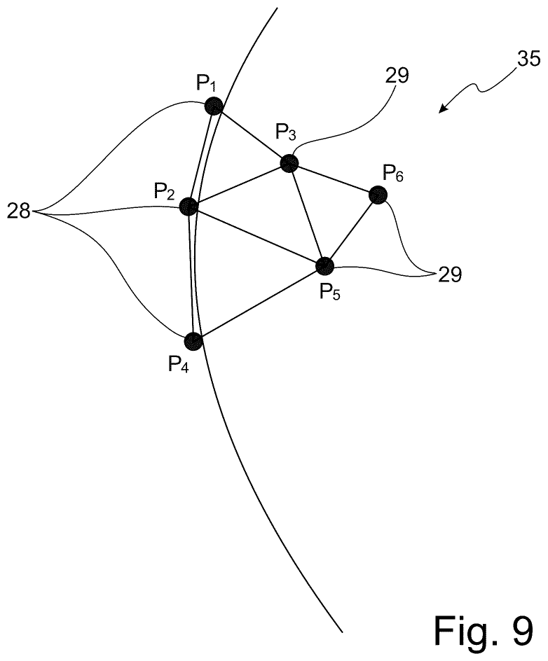

FIG. 9: shows one example of ascertaining further deviations for the unscanned regions,

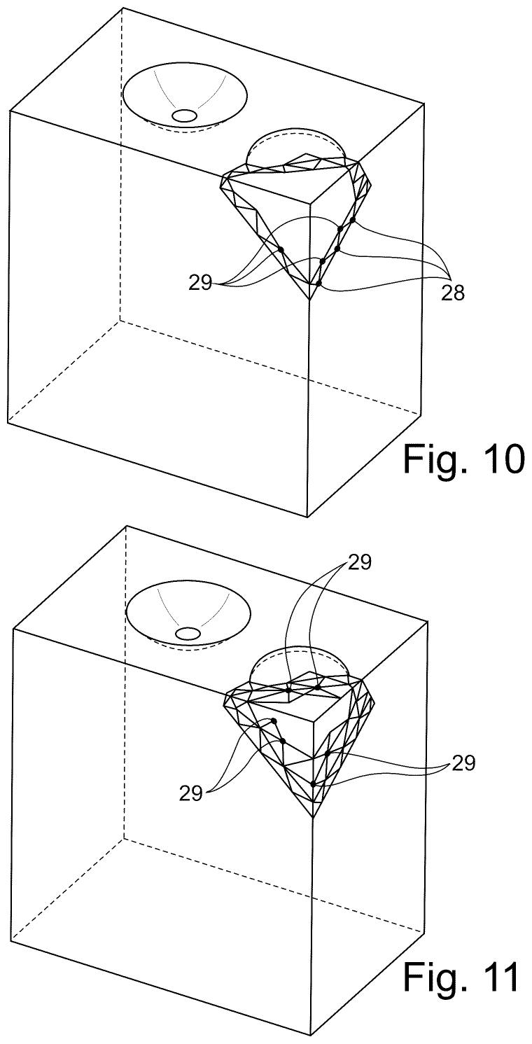

FIG. 10: shows a process of ascertaining further deviations on the basis of known first deviations,

FIG. 11: shows a continuation of ascertaining further deviations in a further row,

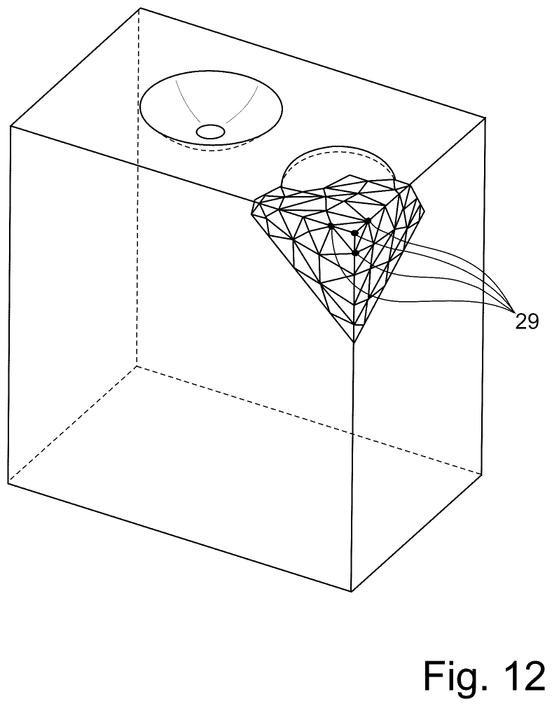

FIG. 12: shows completed generation of deviations for the entire unscanned region,

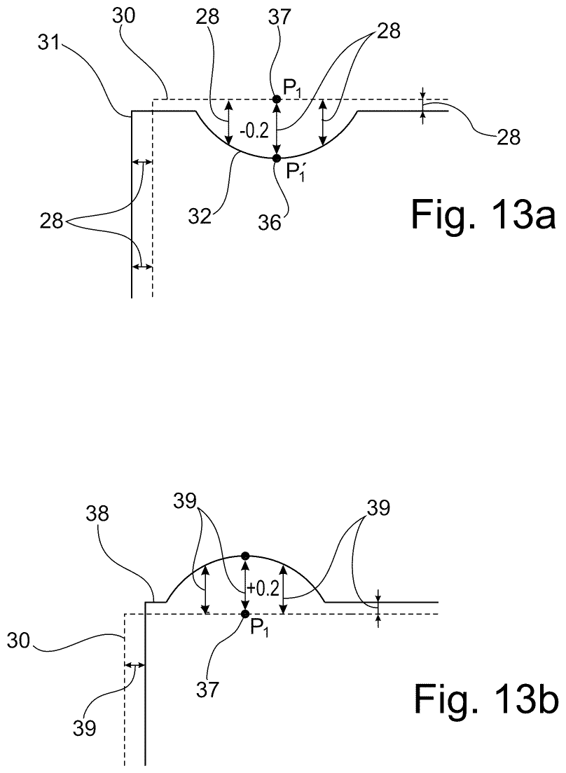

FIG. 13a, 13b: show, in excerpts, a process, which takes place in a deformation step, of deforming and generating the corrected 3D print data, and

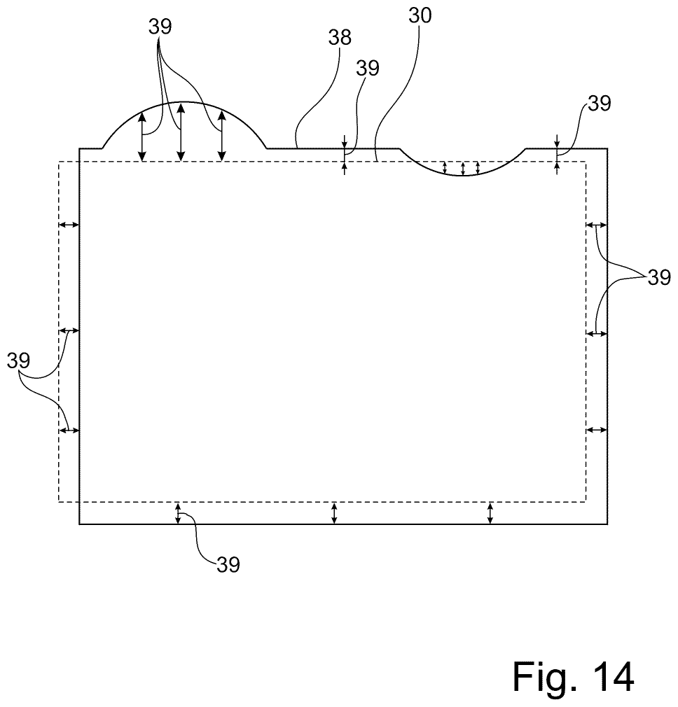

FIG. 14: shows an illustration of a complete deformation or complete generation of the corrected 3D print data.

FIG. 1 shows one example of a flowchart for the method according to the invention.

The method starts in the provision step 1 with the provision of the 3D print data, which are data regarding a desired geometry 30 of a 3D structure to be created. Such 3D print data may be provided for example by a computer-aided design system.

In a conversion step 2, these 3D print data, that is to say the data regarding the target geometry 30 of the 3D structure, are converted once into partial surfaces, such as for example small triangular partial surfaces describing the outer contours of the 3D structure 30 to be created. A triangulation thus takes place in which the surface of the target geometry 30 of the 3D structure to be created is completely covered, for example, by way of triangular partial surfaces.

For these partial surfaces present in a triangular shape, the associated surface normal is determined for each triangular surface and, based thereon, the associated corner normal is calculated for each vertex, these being used in the further method sequence. The data, present in this converted form, regarding the target geometry 30 of the 3D structure are used to subsequently ascertain deviations between corresponding points, that is to say a point P′ 36 on the surface of the actual geometry 31 of the 3D structure and its associated, corresponding point P 37 on the surface of the target geometry 30 of the 3D structure. Here, for example, provision is made, in the case of triangular partial surfaces, for the points P₁, P₂, P₃, . . . , Pₙ to be arranged aligned at the corners of the triangular partial surfaces and for the produced corner normals to run through these points P₁, P₂, P₃, . . . , Pₙ.

In a first slicer step 3, the 3D print data regarding the target geometry 30 of the 3D structure are converted into specific instructions for the creation of individual layers in the 3D printing process. First slice data 4 regarding the target geometry 30 of the 3D structure are then present.

In a first printing step 5, the 3D structure is created in the 3D printing process using the provided layer data 4 in a 3D printer.

After the 3D structure has finished being created in the 3D printer 31, it is removed from the print bed of the 3D printer and cleaned in the post-processing step 6. This post-processing step 6 may also include the processes of hardening, post-processing and transporting the 3D structure 31. Post-processing is understood to mean for example removing support structures and cleaning the created 3D structure 31.

The created 3D structure 31 is measured in three dimensions in the measurement step 7. This measurement process may be performed for example by way of an appropriate laser scanning device (3D scanning device). As a result of such a measurement, three-dimensional, in practice usually incomplete data 34 regarding the actual geometry of the created 3D structure 31 are present. These data are incomplete because there are no data for unscanned regions caused by undercuts, for example. Such unscanned regions 35 arise in the measurement step 7 when parts of the surface of the created actual structure 31 cannot be reached by the sensors of the 3D scanning device or are not “visible” to the 3D scanning device. The data 34 regarding the scanned actual geometry 31 correspond to the model 34, by way of which the data 34 may be represented optically and thus visualized.

Optionally, a further first printing step 5, a further post-processing step 6 and a further measurement step 7 may take place in order to create and measure more than one 3D structure 31 before the method is continued.

As a result of the measurement step 7, data 34 regarding the scanned actual geometry of the created 3D structure 31 are present as a measurement point cloud 8. These three-dimensional data in the measurement point cloud 8 are for example assigned to vertices P₁, P₂, P₃, . . . , Pₙ of the partial surfaces that were used during the process of triangulating the surface of the target structure to be created in order to describe the outer contours of the 3D structure to be created.

In the projection step 9, the data regarding the actual geometry 31 of the created 3D structure and the data regarding the target geometry 30 of the created 3D structure are projected on top of one another or compared with one another. It is thus possible to determine deviations between the actual geometry 31 of the 3D structure and the target geometry 30 of the 3D structure point by point based on corresponding points P 37 and P′ 36 located in the scanned regions. The points P₁, P₂, P₃, . . . , Pₙ 37 are each located here on the surface of the target geometry 30 of the 3D structure, and the associated points P₁′, P₂′, P₃′, . . . , Pₖ′ 36 are each located on the surface of the actual geometry 31 of the 3D structure. The relationship k<n applies here, which means that the number of measurement points recorded during a measurement and that are able to be assigned to points P′ 36 on the actual geometry 31 is less than the number of points P 37 on the target geometry 30.

These determined first deviations 28 or deviation data 28 thus represent the respective distances between a point P 37 and the associated point P′ 36 in the scanned regions. These deviation data 28 are stored, with their ascertained value, in relation to the respective points P₁, P₂, P₃, . . . , Pₙ located on the surface target geometry 30 of the 3D structure.

Since the data 34 generated in the three-dimensional scan regarding the scanned actual geometry 31 of the created 3D structure are incomplete, that is to say include unscanned regions 35, in the subsequent completion step 10, second deviations 29 or second deviation data 29 are generated or interpolated, in accordance with the method, for the unscanned regions 35. In this completion step 10 according to the method, the first deviations 28, ascertained in the projection step 9, in the scanned regions, in particular the identified first deviations 28 between corresponding points P 37 and P′ 36 located at the edges of the unscanned region 35, are used.

After the completion step 10, complete deviation data are available, comprising all of the deviation data 28 and 29 between the 3D structure 30 to be created and the created 3D structure 31, that is to say both the first deviation data 28 ascertained in the scanned regions and the second deviation data 29 ascertained in the unscanned regions 35.

This completion step 10 may optionally be followed by a smoothing step 11 in which the now complete deviation data, that is to say the first deviation data 28 regarding the scanned regions and the second deviation data 29 regarding the unscanned regions, are smoothed or post-processed. For this purpose, by way of example, a deviation 28 or 29 at any point P is corrected with a weighted average for this deviation 28 or 29.

Smoothed complete deviation data 12 are then available, describing all of the differences or all of the deviations between the target geometry 30 of the 3D structure and the actual geometry 31 of the 3D structure for all regions of the surface of the actual geometry 31 of the 3D structure.

Optionally, in the following step, deterministic warpage may be recognized 13 on the basis of an evaluation or analysis of multiple results of multiple three-dimensional scans of multiple created 3D structures 31. By way of example, averages of occurring deviations in relation to points on the surface of the 3D structure may thereby be determined.

As a result of the optional recognition 13, either the complete deviation data determined in step 12 or further-corrected complete deviation data 14 are present and are used in the further method sequence.

In the deformation step 15, corrected 3D print data are generated, containing the deformations or deviations of the actual geometry 31 of the created 3D structure in relation to the specified target geometry 30 of the 3D structure to be created. The existing target model of the 3D structure is deformed in the opposite direction to the ascertained deviations in order, as a result of creating a further 3D structure on the basis of these corrected 3D print data 38, to eliminate or at least minimize the occurring deterministic warpage. In the opposite direction to the ascertained deviations 28, 29 means that an ascertained oversize of for example 0.2 mm at a certain point P₁ 37 on the surface of the 3D structure is corrected by an undersize of 0.2 mm for this certain point P₁ 37. In this deformation, points P₁, P₂, P₃, . . . , Pₙ of the data regarding the target geometry 30 of the 3D structure are displaced in a direction opposite the ascertained deviation 28, 29 and with the magnitude of the ascertained deviation 28, 29 on the basis of the deviation 28, 29 ascertained in relation to the respective point P₁, P₂, P₃, . . . , Pₙ.

The 3D print data generated in the deformation step 15 are then present as deformation data 16 representing the corrected 3D print data 38.

In the following second slicer step 17, the deformation data 16 or the corrected 3D print data 38 regarding the 3D structure are converted into specific instructions for the creation of individual layers in the 3D printing process. Further layer data 18 for creating a further 3D structure are then present.

In a further printing step 19, a further 3D structure is created in the 3D printing process using the provided further layer data 18 in a 3D printer.

After the creation of a further 3D structure in the further printing step 19, the method may be run through again and is continued in the measurement step 7.

As an alternative, provision may be made, in the method sequence, in an alternative deformation step 20, for corrected 3D print data to be generated for the individual layers, these including the deformations or deviations of the actual geometry 31 of the created 3D structure in relation to the specified target geometry 30 of the 3D structure to be created.

The smoothed complete deviation data 12 or the corrected deviation data 14 are used for example to create what are known as layer deformation data 21 from the existing first layer data 4 by way of the known deviations 28, 29 in relation to the respective layers.

The first layer data 4 are likewise deformed in the opposite direction to the ascertained deviations 28, 29 in order, as a result of creating a further 3D structure on the basis of these corrected 3D print data 38, to eliminate or at least minimize the occurring deterministic warpage.

The layer deformation data 21 are converted, in the further method sequence, into second layer data 18, and a further 3D structure is created in a further printing step 19.

FIG. 2 shows one example of a flowchart for the process of completing the missing further deviation data 29 belonging to the unscanned regions 35 of the surface of the created 3D structure 31 in a completion step 10 with the aid of the data target geometry 30 of the 3D structure and the already ascertained first deviations 28 in accordance with the present method.

The input data 22 for the completion step 10 are data regarding the surface of the target geometry 30 of the 3D structure that have already been processed in the conversion step 2 such that the surface of the target geometry 30 of the 3D structure has been reproduced or triangulated by way of small partial surfaces, such as triangles for example, wherein points P₁, P₂, P₃, . . . , Pₙ have been assigned to the corners of the triangles. The input data 22 also include the first deviation values or first deviation data 28 already ascertained in the projection step 9 for the scanned regions.

Based on the already ascertained first deviation data 28 for the scanned regions, in particular the ascertained deviation data 28 in relation to points P₁, P₂, P₃, . . . , Pₙ 37 at the edges of the unscanned regions 35, an interpolation 23 is carried out in which further deviation data 29 in relation to points P₁, P₂, P₃, . . . , Pₙ 37 located in an unscanned region 35 are determined in steps. This interpolation process 23 uses for example the first deviation data 28 known for two points P₁ 37 and P₂ 37, which are located in the scanned region, of a triangular partial surface to ascertain a further deviation value 29 in relation to the point P₃ 37, which is located in the unscanned region 35. In this example, a further deviation value for the point P₃ 37 may be determined such that an arithmetic average is determined from the first deviations 28 known for the points P₁ 37 and P₂ 37 in the interpolation step 23.

This interpolation 23 is continued for example for neighboring triangular partial surfaces with their points P₁, P₂, P₃, . . . , Pₙ 37 along the edge of the unscanned region 35 until for example the associated further deviation values 29 have been determined for all of the points P₁, P₂, P₃, . . . , Pₙ 37 located near the edge of the unscanned region 35 in a first row. The further deviation values or further deviation data 29 ascertained in this way are also stored, with their magnitude, in relation to associated points P₁, P₂, P₃, . . . , Pₙ 37 of the data regarding the target geometry 30 of the 3D structure.

The interpolation 23 may then be carried out for points P₁, P₂, P₃, . . . , Pₙ 37 in an imaginary second row at a greater distance from the edge of the unscanned region 35, and so on. By virtue of this interpolation 23, the further deviation data 29 in relation to points P₁, P₂, P₃, . . . , Pₙ 37 are completed in the unscanned regions 35 from the outside inward, until corresponding further deviation data 29 have been generated in relation to all points P₁, P₂, P₃, . . . , Pₙ 37 located in the unscanned region 35.

The further deviation data 29, generated in this way, in relation to points P₁, P₂, P₃, . . . , Pₙ 37 in the unscanned regions 35 are the output data 24 from the completion step 10.

FIG. 3 shows one example of a sequence for the smoothing step 11. When determining deviations 28 in the scanned regions or when determining further deviations 29 in the unscanned regions 35 or at the transitions between a scanned region and an unscanned region 35, there may be abrupt changes in values of the deviation data 28, 29 for neighboring points P.

The smoothing input data 25 available to the optional smoothing step 11 are the complete deviation data present after the completion step 10 for points P₁, P₂, P₃, . . . , Pₙ 37 in the scanned and unscanned regions 35 of the surface of the target geometry 30 of the 3D structure.

In this smoothing step 11, the gradations that otherwise occur in a subsequent deformation step 15 are reduced by reducing such an abrupt deviation between values of neighboring deviation data 28, 29 by correcting the deviation values 28, 29 ascertained in relation to the corresponding points P₁, P₂, P₃, . . . , Pₙ 37 in each case by way of weighted averaging 26 for the corresponding deviation value.

For this purpose, for example, a weighted average for a point P₁ 37 is determined by processing the deviation value 28 or 29 for the point P₁ 37 itself when carrying out weighted averaging 26 for the point P₁ 37 and processing multiple deviation values 28, 29 for the points P₂, P₃, P₄, . . . , Pₙ directly surrounding and neighboring the point P₁ 37. When using triangular partial surfaces, at least the deviation values 28, 29 of three adjacent points P₂, P₃, P₄ and the deviation value of the point P₁ 37 itself are thus used in the weighted averaging 26.

This smoothing step 11 is performed for a defined number of points P₁, P₂, P₃, . . . , Pₙ 37, for defined points P₁, P₂, P₃, . . . , Pₙ 37, for defined regions or for all points P₁, P₂, P₃, . . . , Pₙ 37 on the surface of the target geometry 30 of the 3D structure. As a result of this smoothing step 11, smoothed or corrected deviation values in relation to points P₁, P₂, P₃, . . . , Pₙ 37 have been generated, these being the smoothing output data 27. These smoothing output data 27 are converted, in the method sequence, into the smoothed complete deviation data 12.

FIG. 4 shows a 3D structure 30 to be created by way of the 3D printing process, that is to say a target geometry 30 of the 3D structure to be created. For this target geometry 30 of the 3D structure, data regarding the target geometry 30 of the 3D structure are present, these being converted, for example, in a first slicer step 3, into specific instructions for the creation of individual layers in the 3D printing process, that is to say first layer data 4 regarding the target geometry 30 of the 3D structure.

In a subsequent first printing step 5, the 3D structure is created in the 3D printing process using the provided layer data 4 in a 3D printer. For better understanding, for FIG. 4 and the following figures, the method steps from FIG. 1 are denoted by their reference numerals, even though these method steps from FIG. 1 are not illustrated in FIG. 4 and the following figures.

FIG. 5 shows a 3D structure 31 created by way of the 3D printing process, that is to say an actual geometry 31 of the 3D structure, for example after the first printing step 5, the hardening and after the post-processing step 6. This created 3D structure 31 corresponds to the data regarding the actual geometry 31 of the 3D structure. A cuboid body has been chosen as the 3D structure to simplify the illustrations. In practice, such 3D structures 31 are designed differently. Even if, in the case of such a cuboid body, unscanned regions do not occur in the 3D scan of the body, this is assumed to be the case here as an example in order to explain the present method in a descriptive manner. The created 3D structure 31 illustrated in FIG. 5 has for example two deviations 32, 33 from the specified target geometry 30. In the example, these deviations are a concave deviation 32 and a convex deviation 33, which are illustrated on a surface of the created 3D structure 31.

The created 3D structure 31 illustrated in FIG. 5 is measured for example in three dimensions in the measurement step 7. A model 34 of the data 34, provided in this measurement step 7, regarding the scanned actual geometry 31 of the 3D structure is illustrated in FIG. 6. This model 34 consists of the measurement point cloud 8 or data in relation to points P′₁, P′₂, P′₃, . . . , P′ₖ 36 mapping the actual geometry 31 of the 3D structure. In the illustration of FIG. 6, only a few points P′₁, P′₂, P′₃, . . . , P′ₖ 36 on the actual geometry 31 of the 3D structure are illustrated by way of example.

By way of example, an unscanned region 35 is illustrated in the illustration of FIG. 6. In this unscanned region 35, no three-dimensional data in relation to points P′₁, P′₂, P′₃, . . . , P′ₖ 36 on the surface of the created 3D structure 31 were ascertained in the measurement step 7, for example because such a region 35 was not “visible” to the sensors of the 3D scanning device.

FIG. 7 shows a sectional illustration through the model 34 illustrated in FIG. 6 or the data regarding the scanned actual geometry 34 along a cutting line AA. FIG. 7 shows that no data regarding the profile of the surface or outer contour of the model 34 are present in the unscanned region 35. In FIG. 7, the concave deviation 32 is illustrated in full, and the convex deviation 33 is illustrated at least in part.

FIG. 8 visualizes the projection step 9, in which the data regarding the actual geometry 31 of the created 3D structure and the data regarding the target geometry 30 of the 3D structure to be created are projected on top of one another or compared with one another. In the projection step 9, first deviations 28 between the actual geometry 31 of the 3D structure and the target geometry 30 of the 3D structure are determined at corresponding points. The data regarding the target geometry 30 are represented by dashed lines, while the data regarding the actual geometry 31 are represented by an unbroken line. FIG. 8 also shows an unscanned region 35 by way of example.

In the projection step 9, the first deviations 28 between corresponding points P 37 and P′ 36, which are located in the scanned regions 35, are determined. The points P₁, P₂, P₃, . . . , Pₙ 37 are each located here on the surface of the target geometry 30 of the 3D structure, and the associated points P′₁, P′₂, P′₃, . . . , P′ₖ 36 are each located on the surface of the actual geometry 31 of the 3D structure. This is illustrated by way of example in FIG. 8 at a first deviation 28 between the point P₁ 37 and the point P′₁ 36, which is located in the region of the concave deviation 32.

The problem also to be solved by the present method is that no first deviations 28 between corresponding points P 37 and P′ 36 are able to be ascertained in the unscanned regions 35.

The determined first deviations 28 or deviation data 28 represent only the respective distances between for example a point P₁ 37 and the associated point P′₁ 36 in the scanned regions. The ascertained first deviations 28 are stored, with their ascertained value, in relation to the respective points P₁, P₂, P₃, . . . , Pₙ 37 located on the surface target geometry 30 of the 3D structure.

FIG. 9 shows one example of ascertaining further deviations 29 for the unscanned regions 35.

FIG. 9 shows a section of a transition from a scanned region to an unscanned region 35 in a zoomed-in illustration.

A prerequisite for ascertaining further deviations 29 is that the surface of the target component is already present in a triangulated form. As described regarding the conversion step 2, the surface of the target geometry 30 of the 3D structure to be created has been completely covered, for example, by way of triangular partial surfaces. Data in relation to neighborhood relationships of points P₁, P₂, P₃, . . . , Pₙ 37 are thus present at the corners of the triangular partial surfaces, which are used subsequently.

Triangular partial surfaces or triangles on the surface of the target geometry 30 are determined, these being located at the edge of the unscanned region 35 and in which first deviation data 28 have already been determined at two corners in the projection step 9. In the example of FIG. 9, this is the first triangular partial surface having the vertices P₁, P₂, P₃, for which first deviations 28 in relation to the vertices P₁ and P₂ are known, since here two first deviations 28 were able to be ascertained between corresponding points P₁ 37 and P′₁ 36 and P₂ 37 and P′₂ 36. However, it is not possible to ascertain deviations between corresponding points P 37 and P′ 36 in the unscanned regions 35, since there are no data in relation to the points P′ 36 in these regions 35.

When determining or ascertaining further deviations 29, it is assumed that the values of the first deviations 28 at the edges of the unscanned region 35 continue into the unscanned region with comparable values for the further deviations 29. In the example, the further deviation 29 for the vertex P₃ of the first triangular partial surface may be determined such that an arithmetic average is ascertained from the first deviations 28 known for the points P₁ and P₂. The ascertained first and further deviations 28 and 29 for the points P₁, P₂ and P₃ have a value for the deviation, wherein the directions of the deviations 28 and 29 each extend along the corner normals associated with the point P₁, P₂ or P₃, these corner normals not being shown in the illustration of FIG. 9.

Ascertaining a further deviation 29 for example for the vertex P₃ by way of arithmetic averaging from the first deviations 28 known for the points P₁ and P₂ is given by way of example. In practice, other calculation rules may be stored in addition to averaging, which take into account for example more complex partial surface constellations encompassing multiple points P, priority weightings for strongly differing first deviations or the degree of uncertainty of a certain further deviation due to the distance from an ascertained first deviation.

After ascertaining the further deviation 29 for the vertex P₃, for example, a further triangular partial surface on the surface of the target geometry 30 is determined, this being located at the edge of the unscanned region 35 and in which first deviation data 28 have already been determined at two corners in the projection step 9. In the example of FIG. 9, this is the second triangular partial surface having the vertices P₂, P₄, P₅, for which first deviations 28 in relation to the vertices P₂ and P₄ are known, since here two first deviations 28 were able to be ascertained between the corresponding points P₂ 37 and P′₂ 36 and P₄ 37 and P′4 36. Ascertaining the further deviation 29 for the vertex P₅ of the second triangular partial surface is again achieved for example by way of arithmetic averaging from the first deviations 28 known for the points P₂ and P₄.

Such ascertaining of further deviations 29 for corresponding vertices P₆, P₇, P₈, . . . , Pₙ of further triangular partial surfaces may for example be continued along the edge of the unscanned region 35 until an imaginary first row of assumed triangular partial surfaces has been formed along the entire edge region. This process of ascertaining further deviations 29 on the basis of known first deviations 28 for corresponding vertices or points P 37 on the surface of the target geometry 30 of the 3D structure to be created is illustrated by way of example in FIG. 10. The triangular partial surfaces shown in the illustration of FIG. 10 are illustrated, by way of illustration, in an illustration with the model 34 in order to visualize the iterative process of ascertaining further deviations 29. As already described, the triangular partial surfaces are the triangular partial surfaces created during the triangulation of the surface of the target geometry 30.

If for example a first row of further deviations 29 has been ascertained close to the edge of the unscanned region 35, the ascertaining of further deviations 29 may be continued in a region further away from the edge of the unscanned region 35, for example in a second row.

This continuation of the ascertaining of further deviations 29 is described by way of the third triangular partial surface, illustrated in FIG. 9, having the vertices P₃, P₅, P₆. In this third triangular partial surface, further deviations 29 in relation to the vertices P₃ and P₅ are ascertained, as described above. The further deviation 29 in relation to the vertex Pol may thus be ascertained in the manner described above.

This continuation of the ascertaining of further deviations 29 in a further imaginary row, wherein this further row is further away from the edge of the unscanned region 35 than the first row, is illustrated by way of example in FIG. 11. The triangular partial surfaces shown in the illustration of FIG. 11 are illustrated, by way of illustration, in an illustration with the model 34 in order to visualize the iterative process of ascertaining further deviations 29 in a further row.

The process of ascertaining further deviations 29 in the unscanned region 35 is continued iteratively in this way until further deviations 29 have been generated, for example for the entire unscanned region 35, as visualized by way of example in FIG. 12.

As may be seen in FIGS. 11 and 12, further deviations 29 are ascertained, according to the method, independently of the surface profile of the created 3D structure 31, which represents a particular advantage of the method.

FIGS. 13a and 13b illustrate the process, which takes place in the deformation step 15, of deforming and generating the corrected 3D print data by way of illustration using two excerpts.

FIG. 13a reproduces an excerpt from FIG. 8, for which it has already been explained that deviations between the actual geometry 31 of the 3D structure and the target geometry 30 of the 3D structure are determined at corresponding points, wherein these first deviations 28 are determined between corresponding points P₁, P₂, P₃, . . . , Pₙ 37 and P′₁, P′₂, P′₃, . . . , P′ₖ 36.

This is illustrated by way of example in the illustration of FIG. 13a at a first deviation 28 for example between the point P₁ 37 and the point P′₁ 36, which is located in the region of the concave deviation 32. The determined first deviations 28 or deviation data 28 represent only the respective distances between a point P 37 and the associated point P′ 36 in the scanned regions and are stored, with their ascertained value, in relation to the respective points P₁, P₂, P₃, . . . , Pₙ 37 located on the surface target geometry 30 of the 3D structure.

In the deformation process, which is shown in FIG. 13b, the points P₁, P₂, P₃, . . . , Pₙ are displaced in the opposite direction to the ascertained deviation 28 or 29 and by a magnitude, dependent on the deviation 28 or 29, of the stored value of the deviation 28 or 29. In this example of FIG. 13, the ascertained first deviation 28 had for example the value −0.2 mm and was directed into the 3D structure, which corresponds to an undersize of 0.2 mm.

The point P₁ in the example is thus opposed so as to generate the corrected 3D print data 38, away from the 3D structure, and displaced outward by the magnitude, ascertained for this first deviation 28, of 0.2 mm from the surface of the target geometry 30 of the 3D structure, as illustrated in FIG. 13b by way of example with the double-headed arrows 39 depicting the deformation.

FIG. 14 shows an illustration of one example of a complete deformation or complete generation of the corrected 3D print data 38, which differ from the original data regarding the target geometry 30 in order thereby to reduce or eliminate deterministic warpage when printing a further 3D structure with the corrected 3D print data 38.

This deformation and the generation of the corrected 3D print data 38 are carried out in the scanned regions by way of the first deviations 28 and in the unscanned regions 35 by way of the ascertained further deviations 29. The deformation is thereby able to take place over the entire surface of the target geometry 30 of the 3D structure. The deformation process is also illustrated by way of example in FIG. 14 by way of the double-headed arrows 39.

In a first alternative, only part of the value ascertained for the deviations may be used in this deformation, for example 50%, 75% or 90% of the value of a deviation in relation to a point P 37.

In a second alternative, the ascertained value of the deviation may be multiplied by a factor in this deformation, and a deformation of for example 110%, 125% or 150% of the ascertained magnitude of a first or further deviation in relation to a point P 37 may thereby be carried out.

### LIST OF REFERENCE SIGNS

1 Provision step
2 Conversion step
3 First slicer step
4 First layer data
5 First print step
6 Post-processing step
7 Measurement step
8 Measurement point cloud
9 Projection step
10 Completion step
11 Smoothing step
12 Smoothed complete deviation data
13 Recognition
14 Corrected complete deviation data
15 Deformation step
16 Deformation data
17 Second slicer step
18 Second layer data
19 Further printing step
20 Alternative deformation step
21 Layer deformation data
22 Input data
23 Interpolation
24 Output data
25 Smoothing input data
26 Weighted averaging
27 Smoothing output data
28 First deviations/first deviation data
29 Further deviations/second deviation data
30 3D structure to be created/target geometry of the 3D structure
31 Created 3D structure/actual geometry of the 3D structure
32 Concave deviation
33 Convex deviation
34 Data regarding the scanned actual geometry/model
35 Unscanned region
36 Point on actual geometry of the 3D structure/P′
37 Point on target geometry of the 3D structure/P
38 Corrected 3D print data
39 Double-headed arrow/deformation

1. A method for producing a 3D structure in a 3D printing process,
in which, for a 3D structure to be created from 3D print data, first layer data for the individual layers of the 3D structure to be created are provided and are used to control the creation of the 3D structure in a 3D printing process, wherein 3D print data are data regarding a target geometry of the 3D structure, characterized in that the method comprising:
measuring a created 3D structure in three dimensions, wherein in practice incomplete three-dimensional data regarding a scanned actual geometry of the 3D structure of a surface of the created 3D structure are generated, these being mapped in a model having one or more unscanned regions;
determining, in a projection step, first deviations between corresponding points P and P′ in the scanned regions, wherein the point P is respectively located on a surface of the target geometry of the 3D structure and the associated point P′ is respectively located on the model of the surface of the scanned actual geometry of the 3D structure;
storing these ascertained first deviations, with their value, as deviation data in relation to associated points P₁, P₂, P₃, . . . , Pₙ of the data regarding the target geometry of the 3D structure;
completing, in a completion step, further deviations belonging to the unscanned regions of the surface of the created 3D structure using the data regarding the target geometry of the 3D structure and the already ascertained first deviation data, wherein the generated further deviation data in relation to associated points P₁, P₂, P₃, . . . , Pₙ of the data regarding the target geometry of the 3D structure are stored with their value, and wherein deviation data completed in this way are generated; and
generating, in a deformation step, corrected 3D print data, in which points P₁, P₂, P₃, . . . , Pₙ of the data regarding the target geometry of the 3D structure are displaced by a magnitude, dependent on the first or further deviation, of the stored value in a direction opposite the ascertained first or further deviation on the basis of the stored first or further deviation ascertained in relation to the respective point P₁, P₂, P₃, . . . , Pₙ,
wherein the corrected 3D print data are used to control the creation of subsequent 3D structures in a 3D printing process.

2. The method as claimed in claim 1, wherein unscanned regions are regions of the surface of the created 3D structure in relation to which no data were able to be generated in the model during the three-dimensional measurement.

3. The method as claimed in claim 1, wherein the surface of the target geometry of the 3D structure to be created is reproduced by way of multiple partial surfaces each having multiple corners in a conversion step, wherein points P₁, P₂, P₃, . . . , Pₙ are assigned to the corners of the partial surfaces.

4. The method as claimed in claim 1, wherein, in the completion step, further deviations in relation to points P₁, P₂, P₃, . . . , Pₙ are ascertained in a first step by generating a further deviation in relation to a point P₁, P₂, P₃, . . . , Pₙ in the unscanned region from multiple ascertained first deviations in relation to points P₁, P₂, P₃, . . . , Pₙ at one or more edges of the unscanned regions by way of a function, and wherein, in a subsequent step, a further deviation in relation to a point P₁, P₂, P₃, . . . , Pₙ in the unscanned region is ascertained from multiple ascertained first deviations or further deviations in relation to points P₁, P₂, P₃, . . . , Pₙ by way of the function.

5. The method as claimed in claim 4, wherein the function is at least one of arithmetic averaging, area-weighted averaging, angle-weighted averaging, or distance-weighted averaging.

6. The method as claimed in claim 1, wherein the ascertaining of further deviations in relation to points P₁, P₂, P₃, . . . , Pₙ in the unscanned region begins at an edge of the unscanned region and is continued in a direction of an assumed center of the unscanned region.

7. The method as claimed in claim 1, wherein, in the deformation step, points P₁, P₂, P₃, . . . , Pₙ are displaced in each case along a corner normal running through the respective point P₁, P₂, P₃, . . . , Pₙ.

8. The method as claimed in claim 1, wherein, after the generation of the further deviations in the completion step, in a smoothing step, the magnitudes, stored in relation to the points P₁, P₂, P₃, . . . , Pₙ, of the first and further deviations are smoothed such that in each case weighted averaging is carried out for each point P₁, P₂, P₃, . . . , Pₙ or selected points P₁, P₂, P₃, . . . , Pₙ and that smoothed complete deviation data are thereby generated.

9. The method as claimed in claim 1, wherein, in the deformation step, the points P₁, P₂, P₃, . . . , Pₙ of the data regarding the target geometry of the 3D structure are deformed for selected points P₁, P₂, P₃, . . . , Pₙ or for all points P₁, P₂, P₃, . . . , Pₙ.

10. The method as claimed in claim 1, wherein, in the deformation step, the points P₁, P₂, P₃, . . . , Pₙ of the data regarding the target geometry of the 3D structure are displaced by a product given by a magnitude, stored in relation to a first or further deviation, as a first factor and a second factor in the range of 0.3 to 1.7.

11. The method as claimed in claim 1, wherein a 3D structure subsequently created by way of corrected 3D print data is measured in three dimensions in order, in accordance with the method, again to ascertain first and further deviations between the target geometry of the 3D structure to be created and the actual geometry of the subsequently created 3D structure, wherein subsequently, in a deformation step, the already corrected 3D print data are deformed at least partially by way of the first and further deviations, wherein further-corrected 3D print data are generated by way of which the creation of a 3D structure to be created subsequently in the 3D printing process is controlled.
